(19) United States
(12) Patent Application Publication
(10) Pub. No.: US 2009/0234871 A1
(43) Pub. Date: Sep. 17, 2009

(54) Method, system and computer program for dynamically merging digital files for download to allow for the addition of advertising, promotional material and merging of files to create albums without embedding additional code

(76) Inventor: Maurice H. Stroemel, JR., State College, PA (US)

Correspondence Address: Maurice Stroemel, Jr., 1044 Taylor St., State College, PA, 16803, US

(21) Appl. No.: 12/077,020

(22) Filed: Mar. 17, 2008

(51) Int. Cl. G06F 17/30

(52) U.S. Cl. 707/101; 707/E17.009

(57) ABSTRACT

Method, system and computer program for dynamically merging digital files for download to allow for the addition of advertising, promotional material and merging of files to create albums without embedding additional code. The digital files are dynamically merged at the time of download, allowing for multiple, different advertisements or files to be served with the same digital file on each download.

### REFERENCE TO SEQUENCE LISTING, A TABLE, OR A COMPUTER PROGRAM LISTING COMPACT DISC APPENDIX

Computer program listing follows detailed description of the invention.

### BACKGROUND OF THE INVENTION

1. Technical Field

The present invention relates to the downloading of digital files over the internet.

2. Description of the Prior Art

The digital download market is growing at an exponential rate. Apple's iTunes recently hit the 4 billion download mark. But it is estimated that illegal downloads are 5 to 10 times the number of legal downloads.

In 2007, 48% of American teenagers did NOT but a CD, But only 29 million people reported downloading music legally.

This huge gap between legal and illegal downloads is the result of a pervasive belief among teenagers and younger adults that music should be free.

A free model is obviously opposed by the music industry and artists, because it deprives them of an opportunity to make a living from their work. The obvious model for free entertainment has been television and radio, which historically has been low cost or free with advertising subsidizing the cost.

Several companies have tried to create advertising driven models for digital downloading, but all of these models present advertisements away from the actual digital file.

### SUMMARY OF INVENTION

The present invention brings the advertising into the medium by dynamically attaching the advertisement to the digital file at the time of download. This ensures that the advertiser's advertisement is in front of the audience at least once and can not be avoided. The value of such an advertisement is increased, and the income derived from the advertisement can then be used to compensate the artist directly. Additionally, the program included herein to effect the merge allows the server to randomly or sequentially choose which advertisement to attach to the file, allowing for rotation of multiple advertisers. Additionally, the method can be used to merge files to create an album. All of this is accomplished without embedding additional code.

### DETAILED DESCRIPTION OF THE INVENTION

The present invention consists of a system for dynamically merging digital files for download, allowing the inclusion of advertising, promotional materials and the merging files to create an album without embedding additional code.

When a user clicks on a link to a digital file, the program identifies the appropriate file on the server. The program then randomly, sequentially or specifically selects a digital file such as an advertisement to attach to the selected file. The program dynamically creates a new file consisting of the digital advertisement and the selected file and offers the new, merged file up for downloading.

Additionally, through the use of a database, the program can monitor the number of times each file is downloaded and make files available or unavailable based on user configuration.

Although the files are attached sequentially without stripping any ID TAGS, the files play on new digital players because they ignore the TAGS.

Through the implementation of the program, the user can, for instance, offer digital downloads for free; allowing advertising revenue to pay artist costs and user costs. This new model allows consumers to download digital files for free with costs being covered by advertising revenue.

The invention could also be used to link digital music files as part of an album download or to link video files to construct various instructional scenarios.

COMPUTER PROGRAM LISTING

```
<?php
ob_start( );
$snippet = $_GET [‘file’] ;
$song = “/home/longtre/bling”.$snippet;
$ad = mt_rand(1, 5);
switch ($ad)
{
case 1:
    $plus = “/home/longtre/ads/ad1.mp3”;
    break;
case 2:
    $plus = “/home/longtre/ads/ad2.mp3”;
    break;
case 3:
    $plus = “/home/longtre/ads/ad3.mp3”;
    break;
case 4:
    $plus = “/home/longtre/ads/ad4.mp3”;
    break;
case 5:
    $plus = “/home/longtre/ads/ad5.mp3”;
    break;
default:
    $plus = “/home/longtre/ads/ad3.mp3”;
}
$avd = file_get_contents($plus);
$mpp3 = file_get_contents($song);
$filename = mt_rand(5000, 1000000).‘.mp3’;
file_put_contents($filename, $avd.$mpp3);
$db=mysql_connect (“localhost”, “$dbuser”, “$dbpassword”) or die (‘I cannot connect to
the database because: ’ . mysql_error( ));
mysql_select_db (“$dbdatabase”, $db);
// Update the downloads table - increment the counter for that page.
$query= mysql_query(“UPDATE downloads SET counter=counter+1 WHERE
file=‘$snippet’”);
// If no row was affected by the last update statement, then there must have been no
previous //download of this file before, so we just need to add it to the table. We use an
INSERT //statement to insert the file name and ‘1’ for the number of downloads.
if (mysql_affected_rows( ) == 0) {
mysql_query(“INSERT INTO downloads (file, counter) VALUES (‘$snippet’, ‘1’)”);
}
$query = mysql_query(“UPDATE downloads SET counter=counter+1 WHERE
file=‘$plus’”);
if (mysql_affected_rows( ) == 0) {
mysql_query(“INSERT INTO downloads (file, counter) VALUES (‘$plus’, ‘1’)”);
}
// The final statement closes the connection to the database.
  mysql_close($db);
// Set headers
  header(“Cache-Control: public”);
  header(“Content-Description: File Transfer”);
  header(“Content-Disposition: attachment; filename=\“$filename\””);
  header(“Content-Type: audio/mpeg”);
  header(“Content-Transfer-Encoding: binary”);
set_time_limit(0);
  ob_end_clean( );
  // Read the file from disk
  readfile($filename);
unlink($filename);
exit;
?>
```

I claim:

1. An apparatus for attaching one digital file to another digital file and serving the new, merged file for download. Comprising:
a central controller including a CPU and a memory operatively connected to said CPU;
at least one terminal, adapted for communicating with said central controller, for transmitting a download request to said central controller;
said memory in said central controller containing a program, adapted to be executed by said CPU, for retrieving requested file, retrieving another randomly or sequentially selected file, dynamically merging the two into a new file and serving the new file to fulfill the request.

2. A method for allowing a requested digital file to be merged with another digital file and served for download comprising the steps of:
inputting a request for a digital file;
randomly, sequentially or specifically selecting another digital file;
merging the first requested digital file with the randomly, sequentially or specifically selected digital file;
Serving the new, merged file for download;
Updating a download database to monitor the number of downloads of each file.
